(19) United States
(12) Patent Application Publication
(10) Pub. No.: US 2021/0333634 A1
(43) Pub. Date: Oct. 28, 2021

(54) BACKLIGHT MODULE AND DISPLAY DEVICE HAVING THE BACKLIGHT MODULE

(71) Applicant: WUHAN CHINA STAR OPTOELECTRONICS TECHNOLOGY CO., LTD., Wuhan, Hubei (CN)

(72) Inventors: Yong YANG, Wuhan, Hubei (CN); Guowei ZHA, Wuhan, Hubei (CN)

(21) Appl. No.: 16/603,677

(22) PCT Filed: Apr. 24, 2019
(86) PCT No.: PCT/CN2019/083987

§ 371 Date: Oct. 8, 2019

(30) Foreign Application Priority Data
Nov. 30, 2018 (CN) 201811452060.1

(51) Int. Cl. G02F 1/13357; G02F 1/1335; F21V 8/00; G02B 6/42

(52) U.S. Cl. CPC G02F 1/133603; G02B 6/4259; G02B 6/0031; G02F 1/133607

(57) ABSTRACT

A backlight module and a display device having the backlight module are provided. The backlight module includes a planar light source having a light-emitting surface; a fluorescent film covering the light-emitting surface of the planar light source; a supporting layer disposed on the fluorescent film, wherein the supporting layer being a transparent gel layer; and a diffusing plate covering the supporting layer. Under the premise of ensuring higher light efficiency, the backlight module and the display device having the backlight module of the present invention reduce the number of the layers of the diffusing plate in the backlight module and increase the light transmittance. Thereby a better light mixing effect, a uniform light mixing realized by a higher light-emitting effect, and a thinner backlight module are achieved.

### FIELD OF INVENTION

The present invention relates to a field of display technologies, and more particularly, to a backlight module and a display device having the backlight module.

### BACKGROUND OF INVENTION

mini-LEDs, also known as “sub-millimeter light emitting diodes,” means that die size of the light emitting diodes (LEDs) is approximately 100 microns. Due to their high brightness, flexibility, low power consumption, lightweight, and the capability to make narrow-frame samples, mini-LEDs have attracted wide attention from many manufacturers.

When assembling a backlight module, mini-LEDs, with uniform light mixing and higher light efficiency, are required. The uniform light mixing can be achieved when using a single diffusing plate with a certain distance for light mixing, or by multi diffusing plates. As shown in FIG. 1, in a current backlight module 9, when using a single diffusing plate, spacing pillars 91 and an air layer 92, are used for as a supporting layer 93 to increase the distance for light mixing. However, the distance for light mixing brings a major challenge to mass production of mini-LED backlight module, which results in a lower yield and is hard to reduce costs. In detail, as shown in FIG. 2, FIG. 2 is a cross-sectional view of the backlight module using the light mixing mode of FIG. 1. As can be seen from FIG. 2, the spacing pillars 91, as shown in FIG. 1, cannot be disposed in the backlight module 9, which results in a gap between a planar light source 94 and the diffusing plate 90. However, the loosening or the falling off of the diffusing plate caused by gravity or oscillation changes the gap, which results in a non-uniform light mixing of mini-LED. Therefore, in the process of assembling the backlight module 9, the mass production of the light mixing mode, using a single diffusing plate 90 with a certain distance for light mixing, cannot be realized due to the restriction of a sealant frame 8, and reliability of the product may be risky. In addition, the light mixing mode, using multi diffusing films, will reduce the light efficiency of mini-LED. How to realize mini-LED backlight module under the premise of ensuring light efficiency and light mixing effect become a key problem to be solved in the process of applying mini-LEDs.

### SUMMARY OF INVENTION

For solving the aforementioned problems, the present invention provides a backlight module and a display device having the backlight module, in which the spacing pillars and the air layer are replaced by a transparent gel layer to increase the distance for light mixing, such that the diffusing plate are supported in the backlight module. Under the premise of ensuring higher light efficiency, the number of layers of the diffusing plate in the backlight module is reduced, thereby a uniform light mixing and a thinner backlight module are achieved.

The technical solution for solving the aforementioned problems is providing a backlight module. The backlight module includes a planar light source having a light-emitting surface, a fluorescent film covering the light-emitting surface of the planar light source, a supporting layer disposed on the fluorescent film, wherein the supporting layer being a transparent gel layer, and a diffusing plate covering the supporting layer.

In one embodiment of the present invention, the thickness of the transparent gel layer is d.

d=d₁(n₂²−n₁² sin²α)^{0.5}/(n₀−n₁² sin²α)^{0.5}

Wherein d₁ is the thickness required when the supporting layer is an air layer, n₀ is a refractive index of the air layer, n₁ is a refractive index of the fluorescent film, n₂ is a refractive index of the transparent gel layer, α is the incident angle of light entering the supporting layer from the fluorescent film.

In one embodiment of the present invention, the refractive index of the fluorescent film is 1.1 to 1.4.

In one embodiment of the present invention, the planar light source includes a substrate having a plurality of metal traces on one surface of the substrate, and a plurality of chips disposed on the substrate and correspondingly connected to the metal traces.

In one embodiment of the present invention, the planar light source further includes a reflective layer, the reflective layer covers one surface of the substrate, and the surface has the metal traces.

In one embodiment of the present invention, the reflective material used for the reflective layer is one of phenolic resin, epoxy resin, polyimide resin, polyester resin, and white oil.

In one embodiment of the present invention, the chip is a blue chip, and size of the chip is 100 μm to 500 μm.

In one embodiment of the present invention, the number of layers of the diffusing plate is one.

In one embodiment of the present invention, the backlight module further includes a prism disposed on the diffusing plate.

The present invention further provides a display device, including a backlight module as aforementioned, and a sealant frame, wherein the sealant frame wraps a side of the backlight module.

The beneficial effect: in the backlight module and the display device having the backlight module of the present invention, the spacing pillars and the air layer are replaced by a transparent gel layer to increase the distance for light mixing, such that the diffusing plate are supported in the backlight module. Under the premise of ensuring higher light efficiency, the number of layers of the diffusing plate in the backlight module is reduced, and the light transmittance is increased. Thereby a better light mixing effect, a uniform light mixing realized by a higher light-emitting effect, and a thinner backlight module are achieved.

### DESCRIPTION OF DRAWINGS

In order to more clearly illustrate the technical solutions in the embodiments or the prior art, the following drawings, which are intended to be used in the description of the embodiments or the prior art, will be briefly described. It will be apparent that the drawings and the following description are only some embodiments of the present invention. Those of ordinary skill in the art may, without creative efforts, derive other drawings from these drawings.

FIG. 1 is a cross-sectional view of a backlight module of the prior art.

FIG. 2 is a cross-sectional view of the packaged backlight module in FIG. 1.

FIG. 3 is a cross-sectional view of a backlight module according to one embodiment of the present invention.

FIG. 4 is a cross-sectional view of a planar light source according to one embodiment of the present invention.

FIG. 5 is a structural distributing diagram of metal traces and solder pads according to one embodiment of the present invention.

FIG. 6 is an optical path diagram of the light refracted in an air layer of the prior art.

FIG. 7 is an optical path diagram of the light refracted in a transparent gel layer according to one embodiment of the present invention.

FIG. 8 is a schematic structural diagram of a display device according to one embodiment of the present invention, which reflects a packaged backlight module.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, “left”, “right”, “inside”, “outside”, “side”, etc., is used with reference to the orientation of the figure(s) being described. As such, the directional terminology is used for purposes of illustration and is in no way limiting. Throughout this specification and in the drawings like parts will be referred to by the same reference numerals.

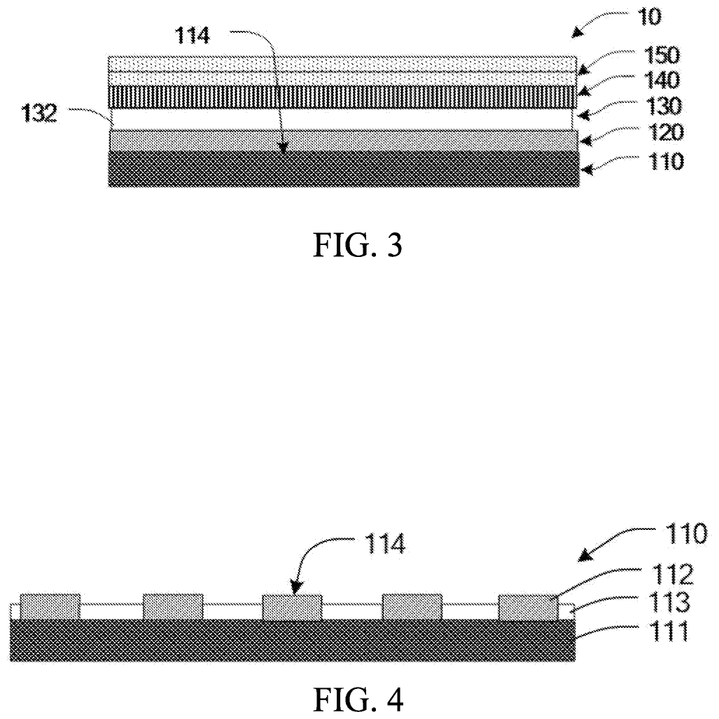

As shown in FIG. 3, in one embodiment, a backlight module 10 includes a planar light source 110, a fluorescent film 120, a supporting layer 130, a diffusing plate 140, and a prism 150.

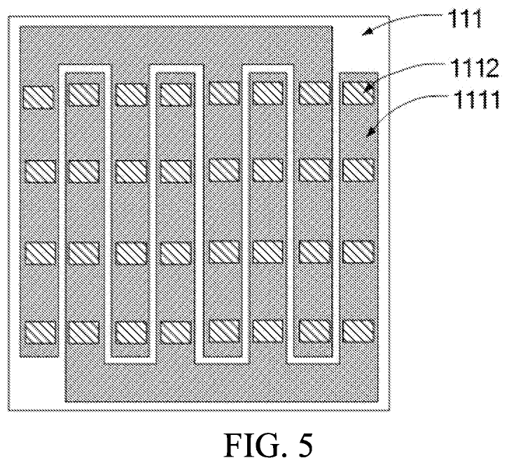

As shown in FIG. 4, the planar light source 110 has a light-emitting surface 114. In this embodiment, the planar light source 110 includes a substrate 111, a plurality of chips 112, and a reflective layer 113. One surface of the substrate 111 has a plurality of metal traces 1111 and a plurality of solder pads 1112, as shown in FIG. 5. FIG. 5 is a structural distributing diagram of the metal traces 1111 and the solder pads 1112 of the substrate 111.

Please refer to FIG. 4 and FIG. 5, the chip 112 is disposed on the substrate 111, and the chip 112 is correspondingly soldered to the solder pad 1112 on the metal trace 1111. The reflective layer 113 covers one surface of the substrate 111, and the surface has the metal traces 1111.

In the die bonding process, a reflective material is coated on one surface of the substrate 111 to form the reflective layer 113. The reflective layer 113 covers the metal traces 1111 on the substrate 111 to improve the refractive index and the reflectivity so that the brightness of the lamp beads can be improved after sealing. The reflective material may be phenolic resin, epoxy resin, polyimide resin, polyester resin, white oil, or the like. In this embodiment, the reflective material used for the reflective layer 113 is whit oil. Then the die bonding process is performed by a reflow soldering technique.

In this embodiment, the chips 112 are disposed on the substrate 111 in an array. Size of the chip is 100 μm to 500 μm, and 20 to 50 pieces of the chips 112 are disposed in per square centimeter. If a six-inch screen is in need, the number of the chips 112 disposed on the corresponding substrate 111 is 100 to 5000. Considering production costs and other issues, in manufacturing the planar light source 110, the use of the chip 112 with small size is much preferred, and the number of the chips 112 also needs to be control. In per square centimeter, the preferred number of the chips 112 is 30, and preferred size of the chip is 200 μm.

As shown in FIG. 3, the fluorescent film 120 covers the light-emitting surface 114 of the planar light source 110; that is, after the chips 112 are disposed, the fluorescent film 120 is overlaid on the chip 112, and color conversion is performed by the fluorescent film 120. In this embodiment, the chip 112 is a blue chip, and the fluorescent film 120 serves as a color conversion device and converts light emitted by the blue chip to green light or red light.

The supporting layer 130 disposed on the fluorescent film 120. In this embodiment, the supporting layer 130 is a transparent gel layer 132 (see FIG. 3). The material used as the transparent gel layer 132 may select from one of silicone, acrylic resin, unsaturated polyester, polyurethane, and epoxy resin. The transparent gel layer 132 may be attached to the surface of the fluorescent film 120 by hot pressing or gluing.

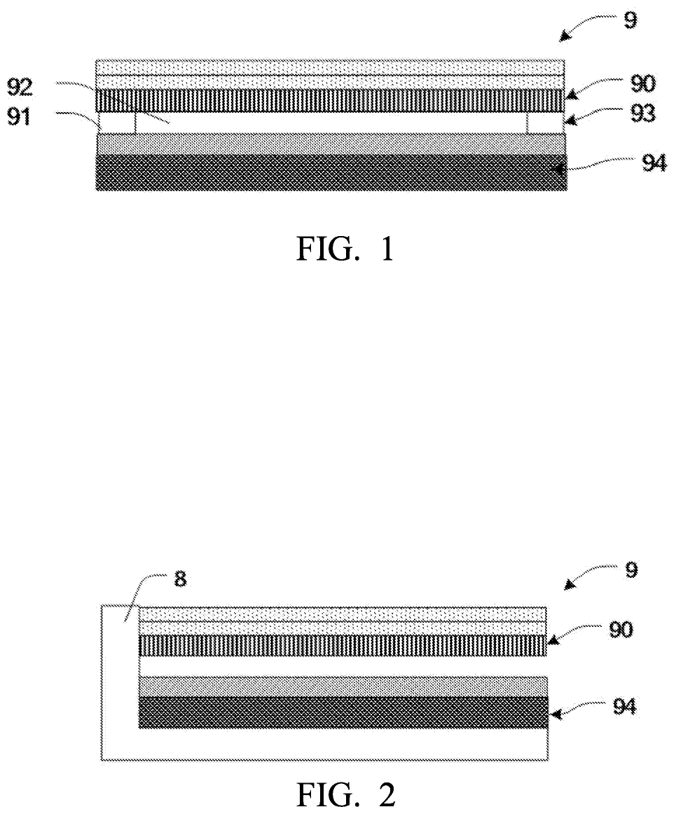

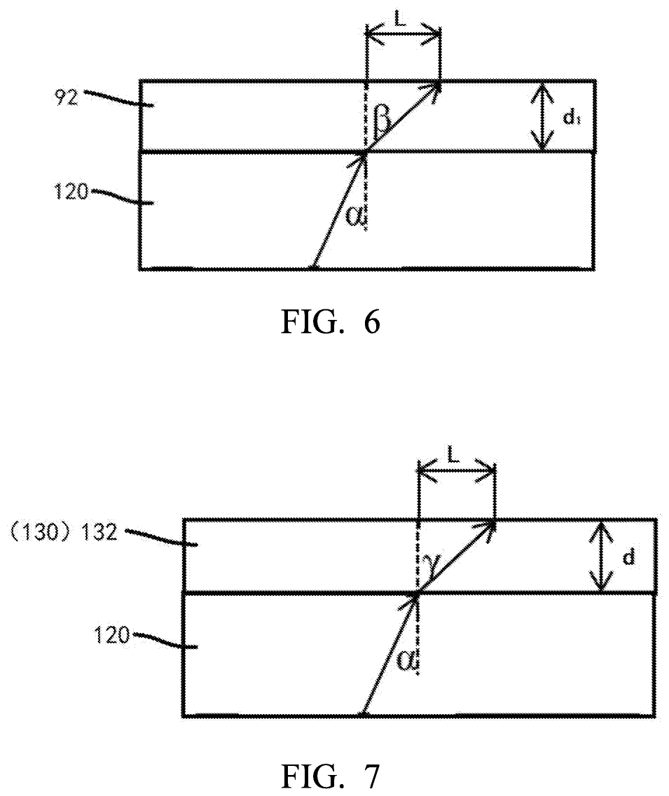

Since the light mixing efficiency is related to the refractive index, thickness, and the like of the transparent gel layer 132, please refer to FIG. 6 and FIG. 7. FIG. 6 is an optical path diagram of the light refracted in an air layer 92 of the prior art. In FIG. 6, the spacing pillar 91 and the air layer 92 as shown in FIG. 1 are used as the supporting layer 93 to increase the distance for light mixing. FIG. 7 is an optical path diagram of the light refracted in a transparent gel layer 132 according to one embodiment of the present invention. In FIG. 7, the transparent gel layer 132 is use as the supporting layer 130 to increase the distance for light mixing.

In this embodiment, the thickness of the transparent gel layer is d, and

d=d₁(n₂²−n₁² sin²α)^{0.5}/(n₀−n₁² sin²α)^{0.5},

wherein d₁ is the thickness required when the supporting layer 130 is the air layer 92, n₀ is a refractive index of the air layer 92, n₁ is a refractive index of the fluorescent film 120, n₂ is a refractive index of the transparent gel layer 132, α is the incident angle of light entering the supporting layer 130 from the fluorescent film 120.

As can be seen, the thickness of the transparent gel layer 132 is related to the refractive index of the fluorescent film 120, wherein a transparent medium material having a lower refractive index is helpful for thinning the thickness of the transparent gel layer 132. Therefore, in this embodiment, the refractive index of the fluorescent film 120 is 1.1-1.4, and the refractive index can be selected from 1.12, 1.13, 1.15, 1.21, 1.33, and the like.

As shown in FIG. 3, the diffusing plate 140 is covered the supporting layer 130. In general, the diffusing plate 140 may adopt a single-layered structure or a multi-layered structure. In this embodiment, a single-layered structure is adopted. The prism 150 is disposed on the diffusing plate 140. The diffusing plate 140 with a single-layered structure increases the module transmittance, thereby a better light mixing effect and a higher light-emitting effect are achieved.

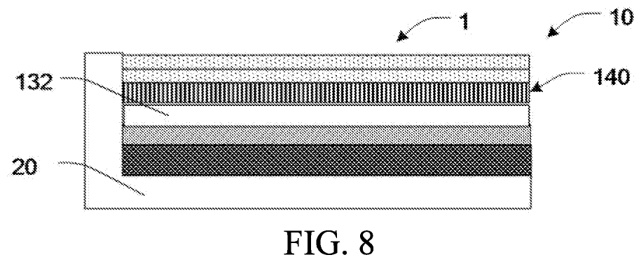

As shown in FIG. 8, in one embodiment of the present invention further provides a display device 1, the display play 1 may be a mini-LED display device, and the mini-LED display device is taken as an example to further explain the structure thereof.

The mini-LED display device includes a backlight module 10, and a sealant frame 20, wherein the sealant frame 20 wraps a side of the backlight module. Since the diffusing plate 140 in the backlight module 10 is located on the transparent gel layer 132, the transparent gel layer 132 may serve as a supporter and enhance the mechanical reliability of the backlight module 10. At the same time, the distance for light mixing of the mini-LED display device 1 is realized by the transparent gel layer 132. Moreover, the number of layers of the diffusing plate is one, which increases the light transmittance. Thereby a better light mixing effect and a higher light-emitting effect are achieved.

The backlight module 10 is the main design of the present invention, and the other structures such as the display panel and the frame are not described herein again.

In view of the above, although the present invention has been disclosed by way of preferred embodiments, the above preferred embodiments are not intended to limit the present invention, and one of ordinary skill in the art, without departing from the spirit and scope of the invention, the scope of protection of the present invention is defined by the scope of the claims.

What is claimed is:

1. A backlight module, comprising:
a planar light source having a light-emitting surface;
a fluorescent film covering the light-emitting surface of the planar light source;
a supporting layer disposed on the fluorescent film, wherein the supporting layer is a transparent gel layer; and
a diffusing plate covering the supporting layer.

2. The backlight module according to claim 1, wherein thickness of the transparent gel layer is d, d=d₁(n₂²−n₁² sin²α)^{0.5}/(n₀−n₁² sin²α)^{0.5}; wherein d₁ is a thickness required when the supporting layer is an air layer, n₀ is a refractive index of the air layer, n₁ is a refractive index of the fluorescent film, n₂ is a refractive index of the transparent gel layer, α is an incident angle of light entering the supporting layer from the fluorescent film.

3. The backlight module according to claim 2, wherein the refractive index of the fluorescent film is 1.1 to 1.4.

4. The backlight module according to claim 2, wherein the planar light source comprises:
a substrate having a plurality of metal traces on one surface of the substrate; and
a plurality of chips disposed on the substrate and correspondingly connected to the metal traces.

5. The backlight module according to claim 4, wherein the planar light source further comprises a reflective layer, the reflective layer covers one surface of the substrate, and the surface has the metal traces.

6. The backlight module according to claim 5, wherein the reflective material used for the reflective layer is one of phenolic resin, epoxy resin, polyimide resin, polyester resin, and white oil.

7. The backlight module according to claim 4, wherein the chip is a blue chip, and size of the chip is 100 μm to 500 μm.

8. The backlight module according to claim 1, wherein a number of layers of the diffusing plate is one.

9. The backlight module according to claim 1, further comprises a prism disposed on the diffusing plate.

10. A display device, comprising:
a backlight module according to claim 1; and
a sealant frame, wherein the sealant frame wraps a side of the backlight module.
